(19) United States
(12) Patent Application Publication
(10) Pub. No.: US 2014/0349028 A1
(43) Pub. Date: Nov. 27, 2014

(54) PRECOATING METHODS AND COMPOSITIONS

(71) Applicant: AUCKLAND UNISERVICES LIMITED, Auckland (NZ)

(72) Inventor: Kaluachchi Gamage Karnika De Silva, Hillsborough (NZ)

(21) Appl. No.: 14/363,463

(22) PCT Filed: Dec. 6, 2012
(86) PCT No.: PCT/NZ2012/000234

§ 371 Date: Jun. 6, 2014

(30) Foreign Application Priority Data
Dec. 6, 2011 (NZ) 596920

(51) Int. Cl. C09D 4/00; B05D 3/06; B05D 1/36; B05D 1/02

(52) U.S. Cl. CPC C09D 4/00; B05D 1/02; B05D 3/067; B05D 1/36
USPC 427/517; 522/174; 428/413

(57) ABSTRACT

Methods and compositions for precoating a substrate. The method comprises: applying to the substrate a curable precoat forming high solids composition comprising: UV curable resin forming components and a photoinitiator system; and applying UV radiation to cure the curable precoat forming component. The curable precoat forming component is not thermally cured. The high solid compositions may comprise a surface-cure photoinitiator and a through-cure photoinitiator and the UV radiation cures the precoat through its entire depth. A conductive additive in the form of a polymer, fiber, filler, powder etc can be added to facilitate and improve electrostatic adhesion of powders to the substrate.

### TECHNICAL FIELD

The invention relates to precoatings (also known as primers or undercoats) and to methods of precoating substrates. In particular, the invention relates to UV curable liquid precoatings suitable for application to rough or porous surfaces including difficult to coat cement fiber boards, gypsum boards, cement particle boards, oil tempered boards, wood fiber composites such as MDF, plyboard etc, widely used fire, mould and mildew resistant magnesia cement boards (commonly known as magnesia boards) and the like, to obtain much superior aesthetic finishes in preparation for powder coating.

### BACKGROUND ART

Methods of coating substrates can broadly be divided into liquid coatings or powder coatings.

Liquid coatings are generally easier, less challenging and less expensive to apply than powder coatings. Liquid coatings can be applied by conventional techniques such as dipping, painting, roller application and spraying. After being applied to the substrate, the liquid coating can then be cured by a variety of methods including thermal curing, chemical curing or radiation curing.

If it is necessary to build up coating thickness, as is usually the case, then the second and any subsequent liquid coatings must be applied before the preceding layer is fully cured in order to achieve proper adhesion between the layers. This means that the coatings are usually applied on one line, limiting production flexibility.

Powder coatings generally require more complex apparatus to apply along with some form of electrostatic control over the powder particles. However, the final product arising from powder coatings can perform better than those arising from liquid coatings, mainly with respect to durability and aesthetics. Further, it is generally possible to combine two environmentally friendly technologies, UV and powder coating on top of a fully UV cured coating or precoating, which allows for a more flexible approach to production.

There is a particular challenge in powder coating porous or rough moisture containing substrates, such as cement boards or fibre boards or their composites. Cement fiber boards are made from plant extracted cellulose fiber reinforced with cement. Cement particle boards use treated wood flakes as reinforcing agents. Cement acts as binder in both the cases. In terms of load-bearing capacity, cement-bonded particle board is generally 6 mm to 40 mm thickness and is extremely suitable for high load bearing applications. Cement fiber boards are generally of 3 mm to 20 mm thickness and tend to be more suitable for use in decorative applications. Because of their electrical properties, it is difficult to powdercoat these substrate directly.

Cement board retains high levels of moisture and when subjected to curing conditions it can undergo “outgassing”—the tendency of fibrous substrates to vent gases and water vapour during curing that lead to poor surface appearance as a result of pinholes, swollen fibres and non uniform thickness. This can also lead to poor adhesion to the substrate.

Generally speaking, it is necessary to provide a precoating or surface primer (the term precoat will be used herein) to the surface being coated. That is generally because the material that forms the outer surface coat is selected for durability and appearance and may not possess optimal adhesion properties. In addition, high performance surface coatings are often expensive so it is desirable to form the full coating thickness with an underlying layer of less expensive materials if possible.

It is an object of certain preferred embodiments of the invention to provide a solvent-free or substantially solvent-free UV curable precoating that can allow the formation of a uniform, smooth powder coating with good adhesion on cement fiber boards and the like, without exposing the substrates to high heat.

It is an object of the present invention to overcome or ameliorate at least one of the disadvantages of the prior art, or to provide a useful alternative.

### SUMMARY OF THE INVENTION

According to a first aspect the invention provides a method of precoating a substrate comprising: applying to the substrate a curable precoat forming high solids composition comprising:
UV curable resin forming components and a photoinitiator system; and applying UV radiation to cure the curable precoat forming component.
Preferably the curable precoat forming component is not thermally cured.
Preferably the composition comprises a surface-cure photoinitiator and a through-cure photoinitiator and the UV radiation cures the precoat through its entire depth.

The method is particularly suited to a method of precoating a substrate prior to powder coating, that is, in a more particular aspect, the invention provides a method of coating a substrate comprising: applying to the substrate a curable precoat forming composition comprising:

UV curable resin forming components and a photoinitiator system comprising a surface-cure photoinitiator and a through-cure photoinitiator; curing the precoat; and applying a powder coat to the precoat.

In another aspect the invention provides a method of precoating a substrate comprising: applying to the substrate a curable unpigmented precoat forming composition comprising UV curable resin forming components and a BAPO photoinitiator and wherein the unpigmented precoat forming composition is cured with a UV lamp preferably at room temperature.

The UV lamp is preferably Ga or Fe doped lamp, and/or an Hg lamp.
In another broad aspect the invention provides a method of coating a substrate comprising:
applying to the substrate a curable precoat forming composition which comprises UV curable resin forming components and a photoinitiator system;
applying UV radiation to cure the curable precoat forming composition; and
applying a powder coat to the precoat.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The through-cure photoinitiator is for preference a bis acyl phosphine oxide (BAPO) type compound. Examples include: Irgacure 819 (phenyl bis(2,4,6-trimethyl benzoyl) Phosphine oxide, TPO-(2,4,6-Trimethyl Benzoyl Diphenylphosphine Oxide), PI-BP-(Phosphine oxide) etc. The surface cure photoinitiator is for preference an alpha-hydroxyketone or phenylglyoxylate type compound. Examples include Irgacure 184 (1-Hydroxy-cyclohexyl phenyl-ketone), Darocur 1173 (2-Hydroxy-2-methyl-1-phenyl-1-propanone etc.

Preferably the ratio of through cure:surface cure photoinitiator, or the ratio of BAPO:alpha-hydroxyketone or phenylglyoxylate is within the range 1:1 to 1:50, or more preferably 1:2 to 1:25.

Preferably, the method further includes the step of applying UV radiation to cure the curable precoat forming component.

Preferably the UV radiation cures the precoat through its entire depth.

The substrate is preferably difficult to coat substrate such as a porous substrate or waxy substrate. The difficult to coat substrate may be cement chip board, cement fibre board, magnesia board, wood fiber composites such as MDF, Plyboard, oil tempered fibre board or the like.

The composition applied is preferably a high solids/low solvent UV curable composition, most preferably a UV curable composition with ˜100% solids.

The term “100% solids” as used herein has its known meaning in the art, namely, that the composition is solvent free. All of the components in a 100% solids coating are incorporated in the final solid cured composition. As is known in the art, a 100% solids composition is, a viscous liquid based on UV curable resins

A high solids composition is one in which only a very small amount of solvent, say less than 10%, is added, for example, to control viscosity.

Preferably the penetration of UV curable coating into fibers is minimized by using high viscosity coatings.

Preferably, the composition is applied to the substrate by roller coating or spraying. If the composition is applied to the substrate by spraying, then the composition may further include a fast evaporating solvent added to obtain a sprayable viscosity, and the process may further include an evaporation step to remove the fast evaporating solvent prior to curing. Fast evaporating solvents can include, for example toluene, MEK, PMA etc.

Preferably, the curable precoat forming component comprises at least one UV curable resin adapted to take up moisture from the board on curing, for example, a functional acrylate such as PEG400DA.

Preferably, the curable precoat forming component comprises up to ˜1.5% Di basic ether.

The precoat thickness may for preference be built up by the application of two or more layers, the second and any subsequent layers being applied to a cured layer or part cured layer. In one preferred embodiment, the precoat thickness is built up by the application of two thin coatings of ˜10-20 microns each of dry film thickness.

In one embodiment, the first precoat is cured with a low intensity lamp and the second and any subsequent layers are cured with a high intensity lamp preferably at room temperature.

According to a second aspect, the invention provides a curable precoat forming component comprising UV curable resin forming components and a photoinitiator system comprising a surface-cure photoinitiator and a through-cure photoinitiator.

Preferably the composition is a high solids/low solvent composition, more preferably a composition with ˜100% solids.

In some embodiments, the composition further includes a fast evaporating solvent to obtain a sprayable viscosity, and where the process further includes an evaporation step prior to curing.

Preferably the curable precoat forming component comprises at least one UV curable resin adapted to take up moisture from the board on curing, for example, PEG400DA.

Preferably the composition includes around ˜1.5% of a di basic ether.

In some embodiments, compositions and methods include conductive filler selected from organic or inorganic fillers such as carbon black, conductive blacks, CNT polyaniline PEDOT or polypyrrole and its derivatives and their doped versions such as, PEDOT/PSS, PANI/PSS etc, conjugated double bond containing monomer or polymer (with or without acid or hydroxyl functionalities), aluminum, stainless steel, copper powders and fibers the like.

These conductive fillers can be added to enhance the electrostatic attraction needed for powder coating and may be present in an amount of around ˜0.05%-10% in the final formulations.

### DESCRIPTION OF THE INVENTION

The precoating compositions of the present invention include a curable system that generally comprises one or more UV curable resin oligomers and one or more UV curable monomers as a coating forming composition and a photoinitiator system comprising a surface cure photoinitiator and a through cure photoinitiator selected in combination to initiate curing of the curable precoat at the surface and throughout the entire depth of coating layer, even in the presence of pigments.

The UV curable components in the primer are selected to be compatible with the powder coatings or any other topcoat to be applied. The UV curable components preferably do not contain water nor do they contain any substantial amount (i.e. not more than 10 wt %) of organic solvents based on the total weight of the composition. The precoating compositions of the present invention are, for preference, a high solids composition comprising UV curable acrylates such as epoxy, polyester, polyurethanes, and the like with or without acid or hydroxyl functionality that could improve the adhesion, water dilutable resins or combinations thereof.

In a coating with high solids, almost all of the components are incorporated in the final solid cured composition. A high solids composition is, before curing, not necessarily solid and is much more usually is a viscous liquid. A formulation may however contain a small amount of fast evaporating solvent.

Useful UV curable polymeric resins and monomers include, but are not limited to, Ebecryl, Syncryl, Miramer, Laromer/Acronal, Desmolux etc. from suppliers such as Cytec, Galalstaff Multresine, Rahn, BASF, Bayer etc. Blends of several different polymeric resins can also be used.

It is desirable to include at least one UV curable resin that can take up moisture from the board, for example, a polyethylene glycol diacetate such as PEG400DA which can help minimize the detrimental effects arising as a result of moisture trapped in moisture-containing substrates such as cement fiber boards or the like.

The precoating compositions of the present invention are formulated to have a viscosity such that they can wet out the substrate surface and penetrate into the surface fiber structure of the substrate and achieve good adhesion and reinforce the surface fiber. Typically, the viscosity of the precoating compositions of the present invention is in the range of ˜50 cps-10,000 cps at 23° C.

The viscosity of the precoating compositions may be reduced by adding diluents, or a small percentage of a fast evaporating solvent, if required.

Diluents may be added to the precoating compositions of the present invention. Diluents are reactive components similar to the above mentioned resins except they contain only a small number, typically one or two, functional groups (such as acrylate, epoxy, polyester, or polyurethane with or without acid or hydroxyl functionality etc) groups per molecule. These are preferred to solvent or any non-reactive diluents in that they are capable of being chemically bound into the network and thus are not easily volatilized. The viscosity of the diluents could be anywhere around 500 cps, as measured by a Brookfield viscometer at ˜23° C.

One particularly beneficial diluent is Dibasic ester (DBE) which can be added preferably in an amount of ˜1.5%. DBE has a high solvency to polyurethanes, polyesters, epoxy, acrylics, etc due to its high polarity and may additionally provide significant improvement in film properties including flow and levelling as well as reducing or eliminate pinholes, fisheyes and other defects in the subsequently cured film. DBE is a slow-evaporating environmentally friendly solvent.

The primer formulations also include a photoinitiator system comprising two or more photoinitiators which in combination initiate both surface curing and through curing of the curable precoat. Any suitable concentration of photoinitiator can be used, however excessively high concentrations may harm the coating properties and/or unnecessarily increase the cost of the precoat.

The selection of the correct photoinitiator system is important to achieve the desired speed and balance of cure properties of the precoat. Generally alpha hydroxyketone photoinitiators (e.g. 1173 from many PI suppliers, CIBA Irgacure 184, Irgacure 2959, Darocur 1173) or Benzophenone type PIs are preferred when curing unpigmented/clear coatings (sealers). Adding a small percentage of through cure photo-initiator (˜0.2%) can be beneficial to get good adhesion to difficult to coat substrates

Although there are many user friendly PI blends with BAPO+surface cure PIs available to cure top coats they may not be suitable for the purposes of the present application where good through cure and excellent adhesion to difficult to coat substrates are the prime requirements for the application of a powder top coating.

For delivering a good curable primer coating with a pigmented systems, a photoinitiator package with a through cure Bis Acyl Phosphine Oxide (BAPO) type photoinitiator+alpha-hydroxyketone or Benzophenone type photo-initiators are recommended.

The following table gives examples of the classes of initiators that can be used:

| Photo- | | | UV/VIS Absorption |
|---|---|---|---|
| initiator | Chemical Class | Function | Peaks (nm) in methanol |
| Irgacure 819 | Bis-Acyl | through | 295, 370 |
| | Phosphine | cure | |
| | (BAPO type) | (pigmented) | |
| TPO-L | BAPO | through cure | 250, 320, 340, 375 |
| | | (pigmented + | |
| Irgacure 184 | alpha-hydroxy | surface cure | 246, 280, 333 |
| | ketone type | | |
| 1173 | alpha-hydroxy | surface cure | 245, 280, 331 |
| | ketone type | | |
| MBF | Phenylglyoxylate | surface cure | 255, 325 |
| BP | Benzophenone | surface cure | 255, 280, 325 |

The precoating compositions of the present invention may also optionally include one or more of the following:
Reactive diluents to control viscosity;
A small percentage (typically less than 10% by weight) of a rapid evaporation, low viscosity solvent to allow the precoating formulation to wet out the surface of the substrate (but not penetrate into the surface fiber structure) or to allow facilitate spray application.
Wetting agents/surfactants, flow additives, dispersants, anti-foaming/de-foaming additives, slip additives and levelling additives as desired.
Pigments and/or fillers as required to improve the opacity of the formulation, reduce the cost or improve performance. Alumina and TiO₂, particularly zirconia treated TiO₂, give good adhesion of the precoat to the topcoat. Alumina on TiO₂ provides ease of dispersion and flocculation resistance when preparing the pigment base.
Conductive fillers selected from organic or inorganic fillers such as carbon black, conductive blacks, CNT, polyaniline PEDOT or polypyrrole and its derivatives and their doped versions such as, PEDOT/PSS, PANI/PSS etc., conjugated double bond containing monomers or polymers, aluminium, stainless steel, copper powders and fibers the like which can be used to obtain good electro-static attraction of subsequently applied electrostatic spray powders.
UV stabilizers, salts, antioxidants, etc.

The methods of the present invention can be used to apply a coating to any substrate, but will be described with reference to coating a fibre board. Preferably, the fibreboards used are relatively dense cement fiber boards, magnesia boards or wood fiber composites such as MDF, plyboard etc.

The methods of the present invention can be used to build up the precoat layer to a desired thickness either in a single stage or in multiple stages. The method of the present invention preferably includes applying the desired film build in two stages.

Precoating the substrate with a thin coat of substantially solvent free, liquid sealing composition slows down the moisture evolution from the substrate, especially from cement fiber boards which have a high moisture content generally not acceptable for powder coating. In conventional methods that employ thermal curing, for example, the substrate is often preheated and this has the additional effect of driving excess moisture from the substrate. However, preheating is not required with the methods of the present invention.

There is likewise no need to ensure any specific moisture content in the substrate which might otherwise be required to allow build up of sufficient electrical charge for efficient electrostatic application of the powder coating to the substrate. The moisture levels within the thin layer of UV cured precoat have been found to be sufficient for such a purpose.

The precoat can be applied on the surface of the solid substrates by the usual application techniques including for example, roller coating or spray coating at room temperature.

Because the viscosity of the uncured precoat is generally relatively high, penetration into the fibreboard or composite is usually not deep. However, the actual depth of penetration depends upon a variety of factors including the exact viscosity of the coating, the type and amount of the coating composition, the substrate surface temperature and the surface porosity.

The preferred method of application involves passing the substrate along a horizontal conveyor and applying the precoat preferably by roller coating. The substrates may pass through a heating oven if required before UV curing.

Spray application can also be used successfully with the addition of fast evaporating solvents such as ethyl acetate being added to the coating formulation to obtain a sprayable viscosity. The spray coated substrates in that case are usually passed through a heated oven say, at ˜50° C. at about 6 m/min line speed to evaporate the solvents before UV curing.

The dry film thickness of the sealer by any application should not exceed more than the amount required to reduce the cost and improve the adhesion to the substrate. Suitable film quality is achievable with a total film build of from about 1 g/m² to about 2 g/m². That corresponds to 8-25 μm first coat thickness and/or a 8-30 μm second coat thickness. Dry Film Thickness (DFT) in microns=wt of the coating/sq.area×density.

Usually, when a two-stage deposition process is involved, the first coat is cured with one or more low intensity lamps and the second coat is cured with one or more high intensity lamps to obtain good inter-coat adhesion of the precoat layers.

The curing can be carried out using lamp intensities and line speed to obtain optimum cure and adhesion for the specific resin combination chosen. When a pigmented coat is used a semi-cure using a medium intensity Gallium lamp is recommended.

If the precoat is applied in two layers, the second precoat may be applied in a similar manner, with a light sanding between coats to promote good adhesion between the two precoat layers if desired, although this is generally not necessary.

If a clear sealer coat is applied the coat can be cured at room temperature preferably with a Mercury lamp of 80-120 W/cm lamp intensity or a Gallium lamp of ˜80-120 W/cm intensity or both.

A Ga lamp of 120 W/cm² can be used to cure both first and second precoats. The lamp intensities used in the present invention in four wavelength regions (UV A, B C and V) at 6 m/min line speed are illustrated below. UV B is the most important wavelength region for curing UV curable coatings. The exact intensities and the energy output of lamps vary from one UV line to another and optimum cure conditions must be obtained for each line after passing a few samples coated with the precoat under the actual UV lamps used.

Intensities for pigmented coatings used in the present invention are as follows:

| | Total Lamp Intensity | Energy Output |
|---|---|---|
| Wavelength region | W/cm²* | J/cm²* |
| UV-A | 0.09-0.44 | 0.19-0.26 |
| UV-B | 0.24-0.53 | 0.16-0.33 |
| UV-C | 0.03-0.10 | 0.019-0.06 |
| UV-V | 0.25-0.93 | 0.21-0.52 |

*as measured by a UV Puck

A Hg lamp may also be used to cure thin clear coatings successfully. Hg lamps, generally used to cure the surface of the coatings are 80 W/cm²-120 W/cm² intensity lamps under the same line speed as above. Clear sealer cure more easily than pigmented coatings using long wavelength Hg UV lamps with lower energy output as penetration through the coating is easily achieved. The lamp intensities recommended to cure a sealer coat (film weight put on the panel ˜18-24 g/m²). As the lamp intensities and the UV line speed could vary from one UV line to another, the applicator must take care to adjust the line speed and/or lamp intensities to get maximum performance with good adhesion of coatings to the substrates.

Lamp Intensities used to cure the second clear sealer coat are typically as follows:

### Intensities for Unpigmented Coatings:

First Precoat

| Wavelength region | Total Lamp Intensity | Energy Output - J/cm2 |
|---|---|---|
| UV-A | 0.163 | 0.112 |
| UV-B | 0.148 | 0.102 |
| UV-C | 0.025 | 0.017 |
| UV-V | 0.073 | 0.048 |

Second Precoat

| Wave length region | Total Lamp Intensity | Energy Output - J/cm2 |
|---|---|---|
| UV-A | 0.194 | 0.126 |
| UV-B | 0.143 | 0.088 |
| UV-C | 0.029 | 0.019 |
| UV-V | 0.089 | 0.052 |

With Hg lamps 100% surface curing of the first coat could lead to adhesion issues when the second coat is applied. Hence, a lower lamp intensity (˜90% energy output) is recommended in part curing the first coat.

A hybrid powder coating can be applied on the sealed/primed surface of the panel/board using an electrostatic gun, followed by curing at temperatures specified by the coating supplier.

The present method allows the formation of a continuous uniform coating on the substrate including even difficult to coat areas such as sharp edges and corners. Pinholes and other defects on the subsequently powder-coated surfaces can be minimized and even eliminated. The primed substrate exhibits controlled electrical conductivity and also exhibits reinforced surface quality including e.g., stronger surface fiber bond strength and increased impact resistance relative to the untreated substrate.

Additionally, the methods of the invention can minimize, and preferably, eliminate the emission of volatile organic compounds (VOC) associated with the use of conventional solvent-based primer systems.

The methods of this invention are particularly advantageous in sealing/priming porous substrates such as cement fiber substrates, glass fiber nonwoven gypsum boards, magnesia boards, wood fiber composites etc used in interior/exterior installations (walls or ceilings) or cellulosic materials which have high moisture content which are capable of absorbing and trapping moisture that will eventually harm the topcoat, i.e. the powder coating. The main defects include water bubbling at powder curing temperature giving a rough surface finish for the topcoat.

It is also possible to include a conductive filler selected from organic or inorganic fillers such as carbon black, conductive blacks, CNT polyaniline PEDOT or polypyrrole and its derivatives and their doped versions such as, PEDOT/PSS, PANI/PSS etc, conjugated double bond containing monomer or polymer (with or without acid or hydroxyl functionalities), aluminum, stainless steel, copper powders and fibers the like.

These conductive fillers can be added to enhance the electrostatic attraction needed for powder coating and may be present in an amount of around ˜0.05%-10% in the final formulations.

The invention is further illustrated in the following non-limiting examples. All the parts, percentages, ratios, amounts are by weight except otherwise specified. Viscosity adjustment to the precoat to get good wet out on the substrate may be required depending on the supplier of the substrates.

In this case adding small percentage (for example, ˜2%) of a diluent such as HDDA 1,6-hexanediol diacrylate or a fast evaporating solvent (for example, <5%) such as ethyl acetate, ethyl alcohol may be recommended. Slight adjustments to intensity of lamps and/or line speed may also be required to optimize the cure and adhesion of the sealer/primer to the substrate.

When photoinitiators are used, it is important to keep light out of the mixtures at all times, for example, by covering with black polythene.

### EXAMPLES

### Example 1

| Raw Material | Quantity % Weight |
|---|---|
| Resin forming system | 41.06 |
| Difunctional epoxy acrylates | |
| Difunctional aromatic urethane acrylate | |
| Trifunctional aliphatic urethane acrylate | |
| Tetrafunctional polyester acrylate | |
| Hexafunctional aliphatic urethane acrylate | |
| Diluent | 25.74 |
| Mono, Di and tri functional diluents | |
| Anti terra U wetting dispersing agent | 0.13 |
| Titanium oxide | 10.45 |
| Dibasic ester | 1.50 |
| PEG400DA | 1.64 |
| Fillers | 13.75 |
| Photoinitiators | 3.3 |
| BAPO:alpha hydroxyl ketone = 0.62:2.68 | |

The coated cement fiber substrate may pass through an oven at about 50° C. if needed before curing the coating under specified UV lamps.

This example employs high solids formulation of around 98% (w/w).

The precoat was applied in two stages. The first was the roller application of resin to a thickness of about 0.75 microns dry with a Ga lamp at (120 w/cm²) with a line speed of ˜4-6 min/m line speed. The second stage was the roller application of resin to an additional thickness of about 0.18 microns dry with a Ga lamp at (100 w/cm²) with a line speed of ˜4-6 min/m line speed. The exact specifications could vary depending on the UV coating lines. For example, the line speed may have to be decreased to 4 m/min if the curing or the adhesion is not perfect with 6 m/min line speed.

The coated cured panels were passed through a hot oven at ˜50° C.

The precoat scored well in standard tests such as MEK double rubs, where it scored 50+, and crosshatch in which 98% passed.

Subsequent application of a top powder coat on the sealed and primed boards showed a good finish and good coat adhesion measured by the standard crosshatch adhesion test.

### Example 2

| Raw Material | Quantity % Weight |
|---|---|
| Resin forming system | 30.44% |
| Difunctional epoxy acrylates | |
| Difunctional aromatic urethane acrylate | |
| Trifunctional aliphatic urethane acrylate | |
| Tetrafunctional polyester acrylate | |
| Hexafunctional aliphatic urethane acrylate | |
| Diluent | 37.17% |
| Mono, Di and tri functional diluents | |
| PEG400DA | 1.89% |
| Matting/flatting agents | 15.96% |
| Dibasic ester | 1.50% |
| Wetting agent | 0.31% |
| Photoinitiators | 4.19% |
| BAPO:alpha hydroxyl ketone = 0.19:4.00 | |
| Evaporating solvents | 8.53% |

Example 2 employs high solids formulation of around 92% (w/w).

The following specific formulations were found to provide base coats on rough uneven substrates which provided top coats with good adhesion and appearance.

### Example 3

| Raw Material | Quantity % Weight |
|---|---|
| Bisphenol-A epoxy diacrylate | 30-40 |
| MW68 white grind (68% TiO2 - 828 ground into | 5-10 |
| GPTA to less than Heg7) | |
| Diol diacrylate | 9-16 |
| GPTA (glyceryl[4PO] triacrylate) | 8-15 |
| Propylene glycol diacrylate | 12-20 |
| Talc (DC1250) | 7-14 |
| CaCO₃ (Omya 1) | 8-15 |
| Monofunctional diacrylate | 0.5-1.5 |
| PEG 400DA | 1-2 |
| Carboxy resin | 2-5 2-5 0.1-1 |
| Laromer 8765 | |
| carboxy ethyl acrylate | |
| Hydroxy functional methacrylate | 0.5-1.5 |
| Antifoam | 0.5-1.0 |
| Matting agent | 1-3 |
| UVtint Bk | 0.5-2 |
| Photo Initiator blend make up in GPTA | 3-5 |
| BAPO:alpha hydroxyl ketone:benzophenone = | |
| 0.83:1.71:0.2 | |

*25 g special Black100 ground in 75 g GPTA on a 3-roll mill to get fine particle size and then take 25 parts of this and mix with 75 g of GPTA - use 0.5% from this in the formulation)

### Example 4

| | |
|---|---|
| Raw Material | Quantity % Weight |

Pigment Base* - Load to Pot with stirring

| | |
|---|---|
| Epoxy diacrylate | 2.5-5 |
| Methylolpropane triacrylate | 4-8 |
| Aromatic urethane acrylate | 2-6 |
| Methylolpropane triacrylate | 4-8 |
| Polyester tetra-acrylate | 10-13 |

Run until uniform (10 min minimum)

| | |
|---|---|
| Anti terra U wetting (dispersing agent) | 0.13-0.2 |
| Tiona RC 575/595 (titanium dioxide) | 9-12 |
| Aniline Black | 1-3 |

QC - Grind spec - 6.5 Hegman
Add with spindle running until uniform

| | |
|---|---|
| Dibasic ester | 1.5-3 |
| Pigment base* | 35-42 |

Load to a separate pot with stirring

| | |
|---|---|
| Aliphatic urethane acrylate | 10-13 |
| Trimethylolpropane triacrylate | 6-8 |
| Aliphatic urethane acrylate | 10-15 |
| Tripropylene glycol diacrylate | 7-10 |
| PEG400DA | 1.6-3 |
| 1,6-hexanediol diacrylate | 1-3 |

Add with spindle running and run until uniform

| | |
|---|---|
| ASP 400 (filler) | 2.5-5 |
| Talc Superfine 15 | 3.5-5 |
| Omyacal 2 (filler) | 7-10 |

Add with stirring until dissolved, Cover at all
time with black polythene - light sensitive)
Weigh accurately - very important

| | |
|---|---|
| Photo Initiator blend made up | 3.2-4.5 |
| in GPTA BAPO:alphahydroxy | |
| ketone:phenylglyoxylate = | |
| 0.62:0.85:1.83 | |

Add with spindle running

| | |
|---|---|
| Pigment base * | 35-42 |

Run until uniform (10 mts minimum
QC - Grind spec - 7 Hegman, solids ~98% (W)
Cure - DFT ~microns dry, Ga (120 w/cm²) @~4-6 min/m line speed, second coat - microns dry Ga (100 w/cm²)
MEK double rubs −50+, crosshatch - 98% pass
Spray the top powder coat on sealed and primed as above.
Adhesion - check with standard crosshatch adhesion

### Example 5

### Clear Formulation

| | |
|---|---|
| Raw Material | Quantity % Weight |

Load to Pot with stirring

| | |
|---|---|
| Aliphatic urethane acrylate | 10-115 |
| Methylolpropane triacrylate | 9-13 |
| Aliphatic urethane acrylate | 15-18 |
| Methylolpropane triacrylate | 10-14 |
| PEG400DA | 1.5-3 |
| Aromatic urethane acrylate | 1-3 |
| Dipropylene glycol diacrylate | 7-10 |
| Tripropylene glycol diacrylate | 5-8 |
| 1,6-hexanediol diacrylate | 1.3-4 |

Run until uniform (10 mts minimum)

| | |
|---|---|
| Matting agent | 12-14 |
| Levelling agent | 2-3 |
| Aniline black | 1-3 |

QC - Grind spec - 7 Hegman
Add with spindle running until uniform

| | |
|---|---|
| Dibasic ester | 1.4-3 |
| Surfactant | 0.2-0.4 |

Add with stirring until dissolved, Cover at
all time with black polythene - light sensitive)
Weigh accurately - very important

| | |
|---|---|
| Photo Initiator blend made up | 4-6 |
| in GPTA BAPO:alphahydroxy | |
| ketone:phenylglyoxylate = | |
| 0.19:3.36:0.64 | |

Add with spindle running

| | |
|---|---|
| toluene | 1-5 |
| PMA (polymethyl acrylate) | 5-8 |

Run until uniform (10 mts minimum)
QC - Grind spec - 6.5 Hegman, solids ~92%(W)
Cure - DFT ~12-15 microns dry, Ga (120 w/cm²)** @~6-9 min/m line speed, second coat - 10-12 microns dry Ga (120 w/cm²)** @~6-9 min/m line speed, coated panels may pass through a hot oven at ~40° C.
MEK double rubs −50+, crosshatch - 98% pass
Spray the top powder coat on sealed and primed as above.
Adhesion - check with standard crosshatch adhesion

The precoat was applied in two stages. The first was the roller application of resin to a thickness of about 12-15 microns dry with a Ga lamp at (120 w/cm²) with a line speed of ˜6-9 min/m line speed. The second stage was the roller application of resin to an additional thickness of about 10-12 microns dry with a Ga lamp at (120 w/cm²) with a line speed of ˜6-9 min/m line speed. The coated cured panels were passed through a hot oven at ˜40° C.

The precoat scored well in standard tests such as MEK double rubs, where it scored 50+, and crosshatch in which 98% passed.

Subsequent application of a top powder coat on the sealed and primed boards showed a good finish and good coat adhesion measured by the standard crosshatch adhesion test.

Those skilled in the art will be aware that the functionality of the UV resins determines the properties such as hardness, rigidity, elasticity, flexibility, adhesion etc. The exact formulation details can be selected within the range of parameters disclosed to optimise the desired properties of the precoating. For example, increasing the functionality of the resin will increase the harness and reactivity of the resin but will result in a decrease in the level of adhesion, and vice versa.

The optimal composition of the photo-initiator, including the balance of surface-cure and/or through cure photo-initiator can be selected within the range of parameters disclosed to optimise the desired properties of the precoating with an eye upon the other production factors such as the UV source used or the overall transparency of the resin.

The nature and amount of any conductive additive in the precoat will ultimately be dictated by the desired surface resistivity of the precoated substrate and its electrostatic attraction for powder coating. This is not solely a function of the precoat, but is in turn influenced by the nature and the moisture level of the underlying substrate.

In the coating industry, UV curable coating lines differ greatly from one another and operate according to specific guidelines provided by the machine and the UV lamp suppliers. Those skilled in the art will be able to optimize machine and lamp parameters such line speed, lamp intensities, lamp type etc within the range of parameters disclosed to optimise the desired properties of the pre-treatment.

For coatings to perform satisfactorily, they must adhere to the substrates on which they are applied. A variety of recognized methods can be used to determine how well a coating is bonded to the substrate. Commonly used measuring techniques are performed with a pull-off adhesion tester, in which a pressure sensitive tape is applied and removed over cuts made in the coating—A standard method for the application and performance of these tests is available in ASTM D3359.

If “No or only up to 5% paint is coming off with the tape”, then the test is taken as a pass. The methods of the present invention all achieved a pass.

Additionally, the sealed/primed substrate exhibit excellent adhesion to the powder coating such that the substrate does not flake apart when a crosshatch adhesion test is performed.

In all cases, the methods and compositions of the present invention provided properly a sealed substrate ready to topcoat with any suitable powder coating including low cure epoxy-polyester hybrids.

In alternative embodiments, the invention provides a method of precoating a substrate comprising: applying to the substrate a curable unpigmented precoat forming composition comprising UV curable resin forming components and a BAPO photoinitiator and wherein the unpigmented precoat forming composition is cured with a Ga doped lamp.

Surprisingly, it has been found that difficult to coat substrates such as porous substrates or cement chip board, cement fibre board, magnesia boards, wood fiber composites such as MDF, plyboards etc or oil tempered fibre board can be coated using a BAPO photoinitiator in an unpigmented resin with Ga lamp curing. This gives good through-curing, and the use of Ga lamps, with longer wave UV radiation, provides good adhesion to the substrate.

BAPO has not previously been used as a sole photoinitiator since it does not normally result in a fully cured surface (although it may be used as a tie coat, which is a partially cured layer between a primer and a topcoat).

1.-53. (canceled)

54. A method of precoating a substrate comprising:
applying to the substrate a curable precoat forming high solids composition comprising UV curable resin forming components and a photoinitiator system, and applying UV radiation to cure the curable precoat forming component to form a precoat.

55. The method of claim 54, wherein the curable precoat forming component is not thermally cured.

56. The method of claim 54, wherein the composition comprises a surface-cure photoinitiator and a through-cure photoinitiator and the UV radiation cures the composition through its entire depth.

57. The method of claim 54, wherein the substrate is selected from the group consisting of cement chip board, cement fibre board, magnesia boards, wood fiber composites and oil tempered fibre board.

58. The method of claim 54, wherein the composition is a composition with ˜100% solids.

59. The method of claim 54, wherein the composition is applied to the substrate by roller coating or spraying

60. The method of claim 54, wherein the composition is applied to the substrate by spraying, and the composition further includes a fast evaporating solvent to obtain a sprayable viscosity, and where the process further includes an evaporation step prior to applying UV radiation to cure the curable precoat forming component.

61. The method of claim 54, wherein the curable precoat forming component comprises at least one UV curable resin adapted to take up moisture from the board on curing.

62. The method of claim 54, wherein the curable precoat forming component comprises a conductive filler, polymer or additive.

63. The method of claim 54, wherein the composition is applied in two or more coats, the second and any subsequent coat being applied to a cured or part cured first coat.

64. The method of claim 63, wherein the first coat is cured with a low intensity lamp and the second and any subsequent coats are cured with a high intensity lamp.

65. A composition comprising:
a curable precoat forming component comprising UV curable resin forming components and a photoinitiator system comprising a surface-cure photoinitiator and a through-cure photoinitiator.

66. The composition of claim 65, wherein the composition is a composition with ˜100% solids.

67. The composition of claim 65, comprising a fast evaporating solvent to obtain a sprayable viscosity.

68. The composition of claim 65, wherein the curable precoat forming component comprises at least one UV curable resin adapted to take up moisture from the board on curing

69. A method of coating a substrate comprising:
applying to the substrate a curable precoat forming high solids composition which comprises UV curable resin forming components and a photoinitiator system;
applying UV radiation to cure the curable precoat forming composition and form a precoat; and
applying a powder coat to the precoat.

70. The method of claim 69, wherein the substrate is cement chip board, cement fibre board, magnesia board, MDF, plywood, oil tempered fiber boards or any wood fiber composites.

71. The method of claim 69, wherein the photoinitator system comprises a through cure photoinitiator and a surface cure photoinitiator

72. The method of claim 71, wherein the through-cure photoinitiator is a bis acyl phosphine oxide (BAPO).

73. The method of claim 69, wherein the composition is a ˜100% solids composition.

74. The method of claim 69, wherein the composition is applied to the substrate by roller coating or spraying

75. The method of claim 69, wherein the composition is applied to the substrate by spraying, and the composition further includes a fast evaporating solvent to obtain a sprayable viscosity, and where the process further includes an evaporation step prior to applying UV radiation to cure the curable precoat forming component.

76. The method of claim 69, wherein the curable precoat forming component comprises at least one UV curable resin adapted to take up moisture from the board on curing.

77. The method of claim 69, wherein the curable precoat forming component comprises a conductive filler, polymer or additive.

78. The method of claim 69, wherein the composition is applied in two or more coats, the second and any subsequent coat being applied to a cured or part cured first coat.

79. A precoated substrate suitable for powdercoating, having a precoating comprising a UV curable resin forming component and a photoinitiator system, cured or partially cured by UV radiation at room temperature.
